(19) United States
(12) Patent Application Publication
(10) Pub. No.: US 2026/0296429 A1
(43) Pub. Date: Oct. 1, 2026

(54) Method and Device for Entering the Coasting Mode of a Motor Vehicle, Considering an Entry Tolerance Band

(71) Applicant: BAYERISCHE MOTOREN WERKE AKTIENGESELLSCHAFT, Muenchen (DE)

(72) Inventors: Helena DOLINAJ, Muenchen (DE); Miguel LOENNE, Muenchen (DE); Sebastien MATHIEU, Fuerstenfeldbruck (DE)

(21) Appl. No.: 18/996,272

(22) PCT Filed: Jul. 19, 2023
(86) PCT No.: PCT/EP2023/070045

§ 371 Date: Jan. 17, 2025

(30) Foreign Application Priority Data
Jul. 28, 2022 (DE) 10 2022 118 903.1

(51) Int. Cl. B60W 30/18; B60W 50/00

(52) U.S. Cl. CPC B60W 30/18072; B60W 50/0097

(57) ABSTRACT

A device for controlling the coasting mode of a vehicle in the context of a distance control and/or speed control of the vehicle is provided. The device is designed to predict a distance and/or speed profile for the vehicle in the coasting mode based on a current degree of advancement of the vehicle, and to compare the predicted distance and/or speed profile for the vehicle with an entry tolerance band about the target distance and/or target speed of the distance control and/or speed control of the vehicle, which is narrower with respect to at least one tolerance band limit than an exit tolerance band. The device is also designed to enter the coasting mode depending on the comparison.

### BACKGROUND AND SUMMARY

The invention relates to a motor vehicle which is designed to be operated in a coasting mode. In particular, the invention relates to a method and a corresponding device for entry into the coasting mode of a motor vehicle in connection with a distance and/or speed control.

A vehicle with an internal combustion engine may be designed to temporarily disconnect the internal combustion engine from the powertrain of the vehicle and possibly shut it down during a journey to reduce the energy consumption of the vehicle. In other words, the vehicle may be designed to be operated in the coasting mode intermittently during a journey.

This document deals with the technical task of enabling a particularly energy-efficient and/or comfortable coasting mode of a vehicle, in connection with a distance and/or speed control of the vehicle.

The task is achieved by each of the independent claims. Advantageous embodiments are described in the dependent claims, among other things. It should be noted that additional features of a patent claim dependent on an independent patent claim without the features of the independent patent claim or only in combination with a subset of the features of the independent patent claim can form a separate invention that is independent of the combination of all the features of the independent patent claim and that can be made the subject of an independent claim, a divisional application or a subsequent application. This applies equally to technical teachings described in the description which can form an invention independent of the features of the independent patent claims.

According to one aspect, a (control) device for controlling the coasting mode of a (motor) vehicle within the framework of a distance and/or speed control of the vehicle is described. During the operation of the distance and/or speed control the driving speed can be automatically adjusted depending on a target distance (set by the driver) to the vehicle driving (directly) ahead of the vehicle and/or (in the case of free driving) can be adjusted depending on a target speed (set by the driver), in particular can be controlled (to the target distance and/or to the target speed). The distance and/or speed control may use a controller (such as a P, I, and/or D controller) to adjust the driving speed and/or the distance.

The device may be set up to decouple the drive motor (combustion engine) of the vehicle from the powertrain of the vehicle (and, if appropriate, to deactivate the drive motor) in order to start the coasting mode. Alternatively or additionally, the device may be set up to couple the drive motor to the powertrain of the vehicle (and, if appropriate, to activate the drive motor) in order to terminate the coasting mode. The vehicle can roll in the coasting mode without the effect of a propulsion torque and/or a drag torque of the drive motor.

During the coasting mode of the vehicle, therefore, typically no propulsion torque and/or drag torque is caused by the drive motor of the vehicle. If appropriate, no braking torque (due to one or more friction brakes of the vehicle) may be caused during the coasting mode. During the coasting mode, therefore, no active distance and/or speed control may be possible. However, it can be monitored that during coasting mode the distance of the vehicle to the vehicle ahead remains within a predefined (exit) tolerance band around the target distance and/or the vehicle driving speed remains within the predefined (exit) tolerance band around the target speed. Outside of the coasting mode, an active distance and/or speed control can be carried out (to the target distance or to the target speed). The distance and/or the driving speed can be set to the target distance or to the target speed immediately after the end of the coasting mode.

The device can be set up based on the current driving distance of the vehicle (for example, based on the current time and/or based on the current position) to predict a distance and/or speed profile of the vehicle in the coasting mode. The predicted distance and/or speed profile can indicate the temporal and/or spatial distance of the vehicle to the vehicle driving (directly) ahead of the vehicle and/or the driving speed of the vehicle as a function of the driving distance (based on the current driving distance). Here the predicted distance and/or speed profile can extend over a predefined prediction horizon based on the current driving distance. The device can be set up to repeatedly update the predicted distance and/or speed profile (based on a respective current driving distance).

The driving distance can indicate or correspond to the position of the vehicle along the road on which the vehicle is driving. Alternatively or additionally, the driving distance can indicate or correspond to the respective time during the vehicle journey. The prediction horizon can thus correspond to a certain distance and/or time horizon (for example, 100 meters or more, or 500 meters or more; or 10 seconds or more, or 20 seconds or more).

The device can be set up to determine a gradient profile ahead of the road being traversed by the vehicle (for the prediction horizon). This information can be determined based on a digital map for the road network being traversed by the vehicle. The distance and/or speed profile of the vehicle in the coasting mode can then be predicted in a precise manner based on the gradient ahead.

The device can also be set up to provide status data in relation to the state (for example, the current driving speed) of the vehicle and/or in relation to the state (for example, the current driving speed) of the vehicle ahead driving ahead of the vehicle. The distance and/or speed profile of the vehicle in the coasting mode can then be predicted in a particularly precise manner based on the status data.

When predicting the distance and/or speed profile of the vehicle, it can be assumed that the vehicle is in the coasting mode throughout the entire prediction horizon. Furthermore, an assumption can be made about the behavior of the vehicle ahead within the prediction horizon. For example, it can be assumed that the driving speed of the vehicle ahead remains constant during the entire prediction horizon.

The device is also set up to compare the predicted distance and/or speed profile of the vehicle with at least one tolerance band limit of an entry tolerance band around the target distance and/or around the target speed of the distance and/or speed control of the vehicle

The entry tolerance band (which is used for the decision regarding the entry into the coasting mode (i.e., in relation to the start of the coasting mode)) is (in relation to at least one or both tolerance band limits) narrower than the exit tolerance band, which is used to decide about the (subsequent) exit from the coasting mode (i.e., to decide about the end of the coasting mode).

The upper tolerance band limit of the exit tolerance band can be between 3% and 13%, in particular between 5% and 10%, above the target distance and/or above the target speed. For example, the lower tolerance band limit of the exit tolerance band can be between 3% and 13%, especially between 5% and 10%, below the target distance and/or below the target speed.

The upper tolerance band limit of the entry tolerance band can be less than, by a parameterizable reserve value (about 5-10%), the upper tolerance band limit of the exit tolerance band. Alternatively or additionally, the lower tolerance band limit of the entry tolerance band can be greater, in particular by a parameterizable reserve value (about 5-10%), than the lower tolerance band limit of the exit tolerance band.

For example, the entry tolerance band can be 5-20% narrower around the target distance and/or around the target speed than the exit tolerance band.

The device is further set up to start the coasting mode depending on the comparison. In other words, the entry into the coasting mode can be effected depending on the comparison of the predicted distance and/or speed profile with the entry tolerance band.

By using a relatively narrow entry tolerance band for the decision about the entry into the coasting mode, a particularly robust and comfortable coasting mode can be made possible.

The device can be set up to determine a contiguous driving distance section in which the predicted distance and/or speed profile remains within the entry tolerance range, based on the current driving distance. The contiguous driving distance section can be determined in such a way that the predicted distance and/or speed profile at the end of the contiguous driving distance section has the target distance and/or the target speed, or (alternatively) that the predicted distance and/or speed profile at the end of the contiguous driving distance section intersects a tolerance band limit of the entry tolerance band.

The coasting mode can be started only if the temporal and/or spatial length of the contiguous driving progress section is greater than or equal to a (predefined) temporal and/or spatial minimum length. This can result in a particularly comfortable and energy-efficient coasting mode.

The device may be set up to determine whether the predicted distance and/or speed profile of the vehicle (based on the current driving distance) will (again) reach the target distance and/or the target speed at an upcoming driving distance, without first exiting the entry tolerance band.

The coasting mode can be started at the current driving distance only if it is determined that the predicted distance and/or speed profile of the vehicle will reach the target distance and/or the target speed without first exiting the entry tolerance band. Such a condition for entering coasting can result in a particularly comfortable and energy-efficient coasting mode.

The device can be set up while the vehicle is being operated in the coasting mode to predict an updated distance and/or speed profile of the vehicle in the coasting mode based on the respective current driving distance of the vehicle. The predicted distance and/or speed profile can thus be updated repeatedly.

The respective updated, predicted distance and/or speed profile of the vehicle can then be compared with the exit tolerance band (with a tolerance band limit of the exit tolerance band) and the coasting mode can be ended in a robust and comfortable manner depending on the comparison (with the tolerance band limit of the exit tolerance band).

The device can thus be set up to compare the respective updated, predicted distance and/or speed profile of the vehicle with a tolerance band limit of the exit tolerance band around the target distance and/or around the target speed of the distance and/or speed control of the vehicle. In particular, the predicted distance profile of the vehicle can be compared with the upper tolerance band limit of the exit tolerance band around the target distance. Alternatively or additionally, the predicted speed profile of the vehicle can be compared with the lower tolerance band limit of the exit tolerance band around the target speed.

The coasting mode can then be ended in a particularly energy-efficient and/or comfortable way, depending on the one or more comparisons.

The device may be set up to determine an exit driving distance (at which the exit from the coasting mode and/or the transition to active distance and/or speed control is effected) depending on the comparison. The coasting mode can then be ended in a particularly energy-efficient and/or comfortable way at the exit driving distance.

In particular, the device may be set up to determine an intersection driving distance (i.e. an intersection) of the predicted distance and/or speed profile of the vehicle in the coasting mode with the tolerance band limit of the exit tolerance band. An intersection driving distance (i.e., the intersection) of the predicted distance profile with the (upper) tolerance band limit of the exit tolerance band around the target distance can be determined. Alternatively or additionally, an intersection driving distance (i.e., the intersection) of the predicted speed profile with the (lower) tolerance band limit of the exit tolerance band around the target speed can be determined. The exit driving distance can then be determined based on the intersection driving distance. Here the exit driving distance can be at a (if appropriate, predefined) offset value before the intersection driving distance. A particularly comfortable and energy-efficient coasting mode can thus be enabled.

The device may be set up to determine the offset value (for determining the exit driving distance) depending on the value of the acceleration of the vehicle caused by the drive motor of the vehicle during the distance and/or speed control after the end of the coasting mode. The acceleration of the vehicle can be caused (after the coasting mode) to bring the actual speed of the vehicle closer to the target speed and/or to bring the actual distance of the vehicle closer to the target distance to the vehicle ahead that is driving ahead of the vehicle.

The offset value can be determined depending on the value of the acceleration of the distance and/or speed control to ensure that the actual speed and/or the actual distance of the vehicle does not leave the respective exit tolerance band (neither during the coasting mode nor during the distance and/or speed control directly following the coasting mode). In this way, a particularly comfortable coasting mode can be achieved in connection with a distance and/or speed control.

According to another aspect, a (road) motor vehicle (a passenger car or a truck or a bus or a motorcycle) is described, which contains the (control) device described in this document.

According to another aspect, a method for controlling the coasting mode of a (motor) vehicle during distance and/or speed control of the vehicle is described. The method includes the prediction, based on a current driving distance of the vehicle, of a distance and/or speed profile of the vehicle in the coasting mode. The method also includes the comparison of the predicted distance and/or speed profile of the vehicle with an entry tolerance band or with a tolerance band limit of an entry tolerance band around the target distance and/or around the target speed of the distance and/or speed control of the vehicle. The entry tolerance band is typically narrower (with respect to at least one or both tolerance band limits) than the exit tolerance band that is used to decide about the subsequent exit from the coasting mode. The method also includes starting the coasting mode depending on the comparison.

According to another aspect, a software (SW) program is described. The SW program can be set up to be run on a processor (for example on a control unit of a vehicle) and as a result to carry out the method described in this document.

According to another aspect, a storage medium is described. The storage medium may contain a SW program that is set up to be run on a processor and as a result to carry out the method described in this document.

It should be noted that the methods, devices and systems described in this document may be used alone and in combination with other methods, devices and systems described in this document. In addition, any aspects of the methods, devices and systems described in this document can be combined in a variety of ways. In particular, the features of the claims can be combined with each other in a variety of ways. Furthermore, features listed in brackets are to be understood as optional features.

In the following, the invention is described in more detail using exemplary embodiments.

### BRIEF DESCRIPTION OF THE DRAWINGS

FIG. 1 shows exemplary components of a vehicle;

FIG. 2a shows an exemplary driving situation of a vehicle:

FIG. 2b shows an exemplary gradient profile of a roadway;

FIG. 3 shows an exemplary predicted distance and/or speed profile during the coasting mode; and

FIG. 4 shows a flow chart of an exemplary method for entering the coasting mode of a vehicle.

### DETAILED DESCRIPTION OF THE DRAWINGS

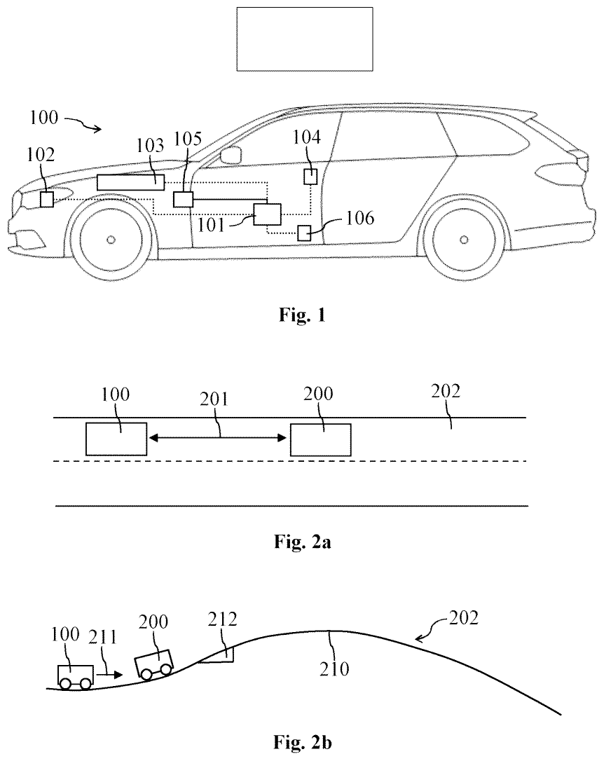

As explained at the outset, this document deals with increasing the energy efficiency and/or comfort of the coasting mode of a motor vehicle that is embedded in the distance and/or speed control of the vehicle. In this context, FIG. 1 shows an exemplary vehicle 100. The vehicle 100 contains one or more environment sensors 102 (for example, at least one camera, one radar sensor, one lidar sensor, and/or one ultrasonic sensor) that are set up to transmit environment data (i.e., sensor data) related to the environment of the vehicle 100. Furthermore, the vehicle 100 contains one or more vehicle sensors 106, which are set up to collect status data (i.e., sensor data) related to a state (for example, related to the driving speed) of the vehicle 100.

A (control) device 101 of the vehicle 100 may be set up to operate the drive motor 103 (the combustion engine) of the vehicle 100 depending on the environment data and/or depending on the status data in order to drive the vehicle 100 longitudinally at least partially automatically. In particular, an automatic distance and/or speed control (Adaptive Cruise Control (ACC)), with which the driving speed of the vehicle 100 is automatically adjusted in order to adjust the distance of the vehicle 100 relative to a vehicle driving ahead directly in front of the vehicle 100 to a target distance (for example, set by the driver of the vehicle 100) and/or to adjust the driving speed of the vehicle 100 during free driving (without a vehicle ahead) to a target speed (for example, set by the driver of the vehicle 100).

FIG. 2a shows an exemplary driving situation in which the vehicle 100 is being driven on a road 202 behind a vehicle ahead 200. The distance 201 between the vehicle 100 and the vehicle ahead 200 is set to a certain target distance by the device 101 of the vehicle 100. The distance 201 can be a spatial distance that corresponds to the spatial distance (for example measured in meters) between the vehicle 100 and the vehicle ahead 200. Alternatively or additionally, the distance 201 can be a time interval corresponding to the time it would take the vehicle 100 at the current driving speed to reach the vehicle ahead 200 (assuming that the vehicle ahead 200 is stationary). The time interval can correspond to the quotient of the current driving speed of the vehicle 100 and the spatial distance between the vehicle 100 and the vehicle ahead 200.

The (control) device 101 can be set up to operate the vehicle 100 at least temporarily in a so-called coasting mode during active distance and/or speed control. For this purpose, the clutch 105 of the vehicle 100 can be caused to decouple the drive motor 103 from the powertrain of the vehicle 100, from the one or more driven wheels of the vehicle 100. Furthermore, a deactivation and/or shutdown of the drive motor 103 can be effected. The vehicle 100 then rolls (without drag torque and/or without drive torque of the drive motor 103) along the road 202 being traversed by the vehicle 100. In this way, the energy consumption of the vehicle 100 can be reduced.

The vehicle 100 can contain a position sensor 104 that is set up to record position data (i.e., sensor data) related to the respective current position of the vehicle 100. The position data can be for example coordinates of a global navigation satellite system (GNSS), such as GPS coordinates. The device 101 may be set up to determine the spatial profile of the road on which the vehicle 100 is travelling based on the position data and on the basis of a digital map related to the road network being traversed by the vehicle 100. If appropriate, a route through the road network) may have been planned using a navigation system of the vehicle 100. Based on the route, it is possible to identify the road 202 along which the vehicle 100 will drive starting from the current time and/or from the current position. Furthermore, the spatial profile, particularly the gradient profile, of the road 202 ahead can be determined on the basis of the digital map.

FIG. 2b shows an exemplary gradient profile 210 of the road 202 being travelled on by the vehicle 100. The gradient profile 210 shows the gradient 212 of the road 202 as a function of the position on the road 202 and/or as a function of the time during a journey (generally as a function of the driving distance of the vehicle 100).

The device 101 can be set up to predict, based on the gradient profile 210 of the road 202 ahead, a distance profile and/or a speed profile of the vehicle 100 in the coasting mode. The distance profile can indicate the (temporal and/or spatial) distance 201 from the vehicle 100 to the vehicle ahead 200 as a function of position and/or as a function of time (generally as a function of driving distance). The speed profile can indicate the driving speed of the vehicle 100 as a function of position and/or as a function of time (generally as a function of driving distance). It can be assumed here that the vehicle 100 is being operated in the coasting mode (without the effect of a drive torque and/or a braking torque generated by the vehicle 100). Furthermore, for the purpose of determination of the distance profile, a certain speed behavior of the vehicle ahead 200 can be assumed; it can be assumed, for example, that the vehicle ahead 200 will drive at a constant driving speed. The distance profile and/or the speed profile can be calculated for a spatial prediction horizon of 50 meters or more, or 100 meters or more (starting from the current position of the vehicle 100) and/or for a time prediction horizon of 5 seconds or more, or of 10 seconds or more.

The activation (also referred to as entry) and/or deactivation (also referred to as exit) of the coasting mode of the vehicle 100 can be carried out in a precise and energy-efficient way (when using the distance and/or speed controller) depending on the predicted distance profile and/or depending on the predicted speed profile. In particular, the device 101 of the vehicle 100 may be set up to predict a distance and/or speed profile of the vehicle 100 in the coasting mode (during operation of the distance and/or speed controller), based on the current position of the vehicle 100 and/or based on the current time (generally, based on the current driving distance). Depending on the predicted distance profile and/or depending on the predicted speed profile, an entry into or exit from coasting the mode can be effected.

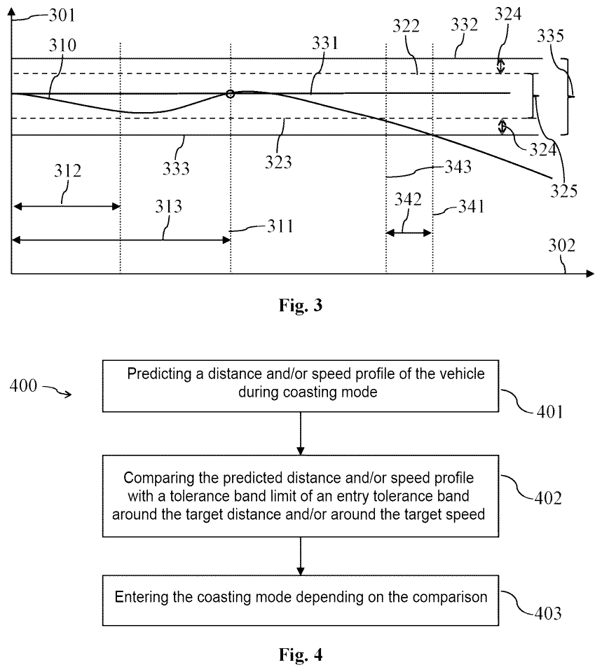

FIG. 3 shows an exemplary predicted distance and/or speed profile 310 during the coasting mode of the vehicle 100. As already explained, the distance and/or speed profile 310 indicates the actual distance and/or the actual speed 301 of the vehicle 100 as a function of the driving distance 302 (for example, as a function of the position and/or as a function of the time) during the journey of the vehicle 100.

FIG. 3 also shows an exemplary tolerance band 335 around the target distance and/or around the target speed 331, with a lower threshold or with a lower tolerance band limit 333 and an upper threshold or an upper tolerance band limit 332 enclosing the target distance and/or the target speed 331. In FIG. 3, a tolerance band 335 around the target speed 331 is shown (for speed control after exiting the coasting mode). The aspects described in this document are applicable accordingly to distance control after exiting the coasting mode.

The device 101 can be set up to determine, based on the predicted distance and/or speed profile 310, that the predicted distance and/or speed profile 310 will intersect a threshold value or tolerance band limit 332, 333 of the tolerance band 335 (the lower threshold 333 of the speed tolerance band 335 and/or the upper threshold 332 of the distance tolerance band 335) at an intersection driving distance 341.

The device 101 may also be set up to cause an exit from the coasting mode at an exit driving distance 343 which is a certain offset value 342 before the intersection driving distance 341. The vehicle 100 may have an actual driving speed 301 at the exit driving distance 343 that is below the target speed 331 (and/or may have an actual distance 301 that is above the target distance 331).

The device 101 may be set up to cause an acceleration of the vehicle 100 (immediately) after the exit from the coasting mode during the distance and/or speed control to accelerate the vehicle 100 to the target speed 331 and/or to cause the vehicle 100 to have the target distance 331.

To provide an energy-efficient and/or comfortable coasting mode, the duration of the coasting phase, during which the vehicle is 100 in the coasting mode, should not be less than a certain minimum duration. It can therefore be checked before entering the coasting mode whether the distance and/or speed profile 310 predicted at the respective time is likely to allow a sufficiently long coasting phase. If this is the case, the entry into the coasting modes can be effected. On the other hand, an entry into the coasting mode can be prevented if necessary.

The predicted distance and/or speed profile 310 is calculated based on a forecast from gradient data from a digital map and/or on the basis of current vehicle data. During the actual coasting process, there may be deviations from the distance and/or speed profile 310 originally predicted (before entering the coasting mode), which can lead to a premature termination of the coasting process, since a limit of 332, 333 of the tolerance band 335 is reached prematurely. It may therefore happen that the actual duration of the coasting phase is shorter than the minimum duration.

In order to take into account such a deviation between the original (before entering the coasting mode) predicted distance and/or speed profile 310 and the actual distance and/or speed profile (during the coasting mode), an entry tolerance band 325 can be used for the decision regarding entry, which is narrower than the exit tolerance band 335, which is used to determine the exit time 343 for the exit from the coasting mode. The entry tolerance band 325 can have an upper tolerance band limit 322, which is, for example, lower than the upper tolerance band limit 332 of the exit tolerance band 335 by a reserve value 324. The lower tolerance band limit 323 of the entry tolerance band 325 can be above the lower tolerance band limit 333 of the exit tolerance band 335 by a reserve value 324. For example, the exit tolerance band 335 can be ±7-12% around the target distance or the target speed 331. The entry tolerance band 325 can be for example ±5-7% around the target distance or the target speed 331.

The device 101 may be set up starting from a specific, current, driving distance 302, before entering the coasting mode, to determine a predicted distance and/or speed profile 310. It can then be checked whether an entry into the coasting mode takes place based on this predicted distance and/or speed profile 310 and based on the entry tolerance band 325. It can be determined whether the predicted distance and/or speed profile 310 remains within the entry tolerance band 325 for a sufficiently long driving distance section or not.

For example, the following one or more conditions can be checked for an entry into the coasting mode,
the predicted distance and/or speed profile 310 has an intersection point 311 with the target distance or with the target speed 331; and/or
the contiguous driving distance section 313, in which the predicted distance and/or speed profile 310 remains within the entry tolerance band 325, has a temporal and/or spatial length that is greater than or equal to a temporal and/or spatial minimum length 312.

The decision regarding the entry into the coasting mode can therefore be made based on the entry tolerance band 325. On the other hand, the decision regarding the exit from the coasting mode can be made based on the exit tolerance band 335. This can further increase comfort and energy efficiency. In particular, the robustness of the coasting mode of the vehicle 100 can be increased. The reserve value 324 or the reserve between the entry tolerance band 325 and the exit tolerance band 335 can be parameterized.

FIG. 4 shows a flow chart of a (possibly computer-implemented) method 400 for controlling the coasting mode of a (motor) vehicle 100 during distance and/or speed control of the vehicle 100, in which the driving speed 401 of the vehicle 100 is set, in particular is controlled, as a function of a target distance 331 to a vehicle ahead 200 and/or (in the case of free travel) as a function of a target speed 331.

The method 400 includes the prediction 401, based on a current driving distance of the vehicle 100 (based on a current point in time and/or based on a current position of the vehicle 100), of a distance and/or speed profile 310 of the vehicle 100 in the coasting mode. The distance and/or speed profile 310 can be predicted based on the profile 210 of the gradient 212 of the road 202 being traversed by the vehicle 100. It can be assumed that the vehicle 100 is in the coasting mode over the entire predicted distance and/or speed profile 310 (and is thus not driven by the drive motor 103 and/or thus no drag torque is caused by the drive motor 103).

The method 400 also includes the comparison 402 of the predicted distance and/or speed profile 310 of the vehicle 100 with an entry tolerance band 325 around the target distance 331 and/or around the target speed 331 of the distance and/or speed control of the vehicle 100. The entry tolerance band 325 is narrower (with respect to at least one or both tolerance bands 322, 323) than the exit tolerance band 335, which is used to decide about the subsequent exit from the coasting mode.

Furthermore, the method 400 includes the beginning 403 of the coasting mode depending on the comparison.

The measures described in this document can be used to achieve a particularly energy-efficient and/or comfortable coasting mode during active distance and/or speed control.

The present invention is not limited to the exemplary embodiments shown. It should be noted that the description and the figures shall only illustrate the principle of the proposed methods, devices and systems by way of example.

1.-11. (canceled)

12. A controller programmed to control a coasting mode of a vehicle by executing a program that causes the controller to:
based on a current driving distance of the vehicle, predict a distance and/or a speed profile of the vehicle in the coasting mode;
compare the predicted distance and/or the predicted speed profile of the vehicle with a tolerance band limit of an entry tolerance band around a target distance and/or around a target speed of a distance and/or speed control of the vehicle to produce a comparison, wherein the entry tolerance band is narrower in relation to at least one tolerance band limit than an exit tolerance band, which is used to decide whether to exit from the coasting mode; and
start the coasting mode depending on the comparison.

13. The controller according to claim 12, wherein the controller is programmed to:
determine, based on the current driving distance, a contiguous driving distance section, in which the predicted distance and/or the predicted speed profile remains within the entry tolerance range; and
start the coasting mode only when a temporal and/or spatial length of the contiguous driving distance section is greater than or equal to a temporal and/or spatial minimum length.

14. The controller according to claim 13, wherein the controller is programmed to determine the contiguous driving distance section in such a way that the predicted distance and/or the predicted speed profile at the end of the contiguous driving distance section has the target distance and/or the target speed, or intersects a tolerance band limit of the entry tolerance band.

15. The controller according to claim 12, wherein the controller is programmed to:
determine whether the predicted distance and/or the predicted speed profile of the vehicle at an upcoming driving distance will reach the target distance and/or the target speed without first leaving the entry tolerance band; and
start the coasting mode at the current driving distance only based on a determination that the predicted distance and/or the predicted speed profile of the vehicle will reach the target distance and/or the target speed without first leaving the entry tolerance band.

16. The controller according to claim 13, wherein the controller is programmed to:
determine whether the predicted distance and/or the predicted speed profile of the vehicle at an upcoming driving distance will reach the target distance and/or the target speed without first leaving the entry tolerance band; and
start the coasting mode at the current driving distance only based on a determination that the predicted distance and/or the predicted speed profile of the vehicle will reach the target distance and/or the target speed without first leaving the entry tolerance band.

17. The controller according to claim 14, wherein the controller is programmed to:
determine whether the predicted distance and/or the predicted speed profile of the vehicle at an upcoming driving distance will reach the target distance and/or the target speed without first leaving the entry tolerance band; and
start the coasting mode at the current driving distance only based on a determination that the predicted distance and/or the predicted speed profile of the vehicle will reach the target distance and/or the target speed without first leaving the entry tolerance band.

18. The controller according to claim 12, wherein the entry tolerance band is 5-20% narrower around the target distance and/or around the target speed than the exit tolerance band.

19. The controller according to claim 13, wherein the entry tolerance band is 5-20% narrower around the target distance and/or around the target speed than the exit tolerance band.

20. The controller according to claim 14, wherein the entry tolerance band is 5-20% narrower around the target distance and/or around the target speed than the exit tolerance band.

21. The controller according to claim 12, wherein
an upper tolerance band limit of the entry tolerance band is less than an upper tolerance band limit of the exit tolerance band by a parameterizable reserve value; and/or
a lower tolerance band limit of the entry tolerance band is greater than a lower tolerance band limit of the exit tolerance band by a parameterizable reserve value.

22. The controller according to claim 13, wherein
an upper tolerance band limit of the entry tolerance band is less than an upper tolerance band limit of the exit tolerance band by a parameterizable reserve value; and/or
a lower tolerance band limit of the entry tolerance band is greater than a lower tolerance band limit of the exit tolerance band by a parameterizable reserve value.

23. The controller according to claim 14, wherein
an upper tolerance band limit of the entry tolerance band is less than an upper tolerance band limit of the exit tolerance band by a parameterizable reserve value; and/or
a lower tolerance band limit of the entry tolerance band is greater than a lower tolerance band limit of the exit tolerance band by a parameterizable reserve value.

24. The controller according to claim 12, wherein, while the vehicle is being operated in the coasting mode, the controller is programmed to:
predict an updated distance and/or updated speed profile of the vehicle in the coasting mode, based on the respective current driving distance of the vehicle;
compare the updated predicted distance and/or the updated predicted speed profile of the vehicle with the exit tolerance band to produce a comparison; and
end the coasting mode depending on the comparison.

25. The controller according to claim 13, wherein, while the vehicle is being operated in the coasting mode, the controller is programmed to:
predict an updated distance and/or updated speed profile of the vehicle in the coasting mode, based on the respective current driving distance of the vehicle;
compare the updated predicted distance and/or the updated predicted speed profile of the vehicle with the exit tolerance band to produce a comparison; and
end the coasting mode depending on the comparison.

26. The controller according to claim 24, wherein the controller is programmed to:
compare the updated predicted distance and/or the updated predicted speed profile of the vehicle with a tolerance band limit of the exit tolerance band around the target distance and/or around the target speed of the distance and/or speed control of the vehicle to produce a comparison;
determine, depending on the comparison, an exit driving distance; and
end the coasting mode at the exit driving distance.

27. The controller according to claim 26, wherein the controller is programmed to:
determine an intersection driving distance of the updated predicted distance and/or the updated predicted speed profile of the vehicle in the coasting mode with the tolerance band limit of the exit tolerance band; and
determine the exit driving distance based on the intersection driving distance, wherein the exit driving distance is before the intersection driving distance by an offset value.

28. The controller according to claim 27, wherein the controller is programmed to determine the offset value as a function of a value of an acceleration of the vehicle which is caused by a drive motor of the vehicle during the distance and/or speed control after the end of the coasting mode to bring an actual speed of the vehicle closer to the target speed and/or to bring the actual distance of the vehicle from a vehicle ahead closer to the target distance.

29. A method for controlling a coasting mode of a vehicle during a distance and/or speed control of the vehicle, the method comprising:
predicting, based on a current driving distance of the vehicle, a distance and/or speed profile of the vehicle in the coasting mode;
comparing the predicted distance and/or the predicted speed profile of the vehicle with a tolerance band limit of an entry tolerance band around a target distance and/or around a target speed of the distance and/or speed control of the vehicle to produce a comparison, wherein the entry tolerance band is narrower in relation to at least one tolerance band limit than an exit tolerance band that is used to decide whether to exit from the coasting mode; and
starting the coasting mode depending on the comparison.
